(19) United States
(12) Patent Application Publication
(10) Pub. No.: US 2006/0241864 A1
(43) Pub. Date: Oct. 26, 2006

(54) Method and apparatus for point-and-send data transfer within an ubiquitous computing environment

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/344,613

(22) Filed: Jan. 31, 2006

Related U.S. Application Data
(60) Provisional application No. 60/673,927, filed on Apr. 22, 2005.

(51) Int. Cl. G01C 21/00

(52) U.S. Cl. 701/213

(57) ABSTRACT

A point-and-send user interface is disclosed wherein a user can point a handheld unit at one of a plurality of electronic devices in a physical environment to select the electronic device and send data to it. Physical feedback can be provided to inform the user of the success and/or other status of the selection and data transfer process. A computer implemented method includes providing a handheld unit adapted to be contacted and moved by a user within a ubiquitous computing environment; receiving sensor data indicating whether the handheld unit is substantially pointed at an electronic device within a ubiquitous computing environment; determining whether an electronic device within the ubiquitous computing environment has been selected by a user based at least in part on the sensor data; and providing the user with physical feedback through the handheld unit upon determining that an electronic device within the ubiquitous computing has been selected.

This application claims the benefit of U.S. Provisional Application No. 60/673,927, filed Apr. 22, 2005, which is incorporated in its entirety herein by reference.

### BACKGROUND

1. Technological Field

Disclosed embodiments of the present invention relate generally to methods and apparatus enabling natural and informative physical feedback to users selecting electronic devices within a ubiquitous computing environment. More specifically, embodiments of the present invention relate to methods and apparatus enabling natural and informative physical feedback to users gaining access to, controlling, or otherwise interfacing with selected electronic devices within a ubiquitous computing environment.

2. Discussion of the Related Art

Known as ubiquitous computing (or pervasive computing), it is currently predicted that a great many networked devices will soon reside in a typical home or office, the devices being individually controllable by a user and/or by one or more computers that coordinate and/or moderate device action. For example, a home or office may include many devices including one or more of a television, DVD player, stereo, personal computer, digital memory storage device, light switch, thermostat, coffee machine, mp3 player, refrigerator, alarm system, flat panel display, automatic window shades, dimmable windows, fax machine, copier, air conditioner, and other common home and/or office devices. It is desirable that such devices be easily configurable by a user through a single handheld device and that a different controller need not be required for every one of the devices. In other words, it is desirable that a plurality of the devices, each located in a different location within a home or office environment, be accessible and controllable by a user through a single handheld unit. When a single handheld unit is configured to interface with multiple devices, an important issue that arises is enabling a user to naturally and easily select among the multiple devices. What is also needed is a method for allowing a user to naturally and rapidly select among multiple devices within a ubiquitous computing environment and selectively control the functionality of the devices. What is also needed is a method for allowing a user to securely link with devices within a ubiquitous computing environment and privately inform the user through natural physical sensations about the success and/or failure of the authentication process.

One promising metaphor for allowing a single device to select and control one of a plurality of different devices within a ubiquitous computing environment is through pointing direction. In such a method, a user points a controller unit at a desired one of the plurality of devices. Once an appropriate pointing direction is established from the controller unit to the desired one of the plurality of devices, the controller is then effective in controlling that one of the plurality of different devices. There are a variety of technologies currently under development for allowing a user to select and control a particular one of a plurality of electronic devices with a single controller by pointing the controller in the direction of that particular electronic device. One such method is disclosed in EE Times article “Designing a universal remote control for the ubiquitous computing environment” which was published on Jun. 16, 2003 and is hereby incorporated by reference. As disclosed in this paper, a universal remote control device is proposed that provides consumers with easy device selection through pointing in the direction of that device. The remote control further includes the advantage of preventing leakage of personal information from the remote to devices not being pointed at and specifically accessed by the user. Called the Smart Baton System, it allows a user to point a handheld remote at one of a plurality of devices and thereby control the device. Moreover, by modulating user's ID (network ID and port number of the users' device), the target devices are able to recognize multiple users' operations so that it can provide differentiated services to different users.

As disclosed in EE times, a smart baton is a handheld unit equipped with a laser pointer, and is used to control devices. A smart baton-capable electronic device, which is controlled by users, has a laser receiver and network connectivity. A CA (certificate authority) is used to authenticate and identify users and devices. When a user points at an electronic device with a smart baton laser pointer, the user's ID travels to the device through the laser beam. Then, the device detects the beam to receive the information from its laser receiver, identifies the user's smart baton network ID and establishes a network connection to the smart baton. After that, an authentication process follows and the user's identity is proven. In this way, the device can provide different user interfaces and services to respective users. For example, the system can prevent children from turning on the TV at night without their parent's permission.

An alternate method of allowing a user to control a particular one of a plurality of electronic devices with a single handheld unit by pointing the handheld unit in the direction of the particular one of the plurality of electronic devices is disclosed in pending US Patent Application Publication No. 2003/0193572 to Wilson et al., which is incorporated in its entirety herein by reference. Wilson et al. can be understood as disclosing a system and process for selecting objects in ubiquitous computing environments where various electronic devices are controlled by a computer via a network connection and the objects are selected by a user pointing to them with a wireless RF pointer. By a combination of electronic sensors onboard the pointer and external calibrated cameras, a host computer equipped with an RF transceiver decodes the orientation sensor values transmitted to it by the pointer and computes the orientation and 3D position of the pointer. This information, along with a model defining the locations of each object in the environment that is associated with a controllable electronic component, is used to determine what object a user is pointing at so as to select that object for further control.

Wilson et al. appears to provide a remote control user interface (UI) device that can be pointed at objects in a ubiquitous computing environment that are associated in some way with controllable, networked electronic components, so as to select that object for controlling via the network. This can, for example, involve pointing the UI device at a wall switch and pressing a button on the device to turn a light operated by the switch on or off. The idea is to have a UI device so simple that it requires no particular instruction or special knowledge on the part of the user. In general, the system includes the aforementioned remote control UI device in the form of a wireless RF pointer, which includes a radio frequency (RF) transceiver and various orientation sensors. The outputs of the sensors are periodically packaged as orientation messages and transmitted using the RF transceiver to a base station, which also has a RF transceiver to receive the orientation messages transmitted by the pointer. There may also be pair of digital video cameras each of which is located so as to capture images of the environment in which the pointer is operating from different viewpoints. A computer, such as a PC, is connected to the base station and the video cameras. Orientation messages received by the base station from the pointer are forwarded to the computer, as are images captured by the video cameras. The computer is employed to compute the orientation and location of the pointer using the orientation messages and captured images. The orientation and location of the pointer is in turn used to determine if the pointer is being pointed at an object in the environment that is controllable by the computer via a network connection. If it is, the object is selected.

The pointer specifically includes a case having a shape with a defined pointing end, a microcontroller, the aforementioned RF transceiver and orientation sensors which are connected to the microcontroller, and a power supply (e.g., batteries) for powering these electronic components. The orientation sensors include an accelerometer that provides separate x-axis and y-axis orientation signals, and a magnetometer that provides separate x-axis, y-axis and z-axis orientation signals. These electronics were housed in a case that resembled a wand. The pointer's microcontroller packages and transmits orientation messages at a prescribed rate. While the microcontroller could be programmed to accomplish this task by itself, a command-response protocol was employed. This entailed the computer periodically instructing the pointer's microcontroller to package and transmit an orientation message by causing the base station to transmit a request for the message to the pointer at the prescribed rate. This prescribed rate could for example be approximately 50 times per second.

A number of deficiencies are associated with the methods disclosed above. For example, to gain access to, control, or otherwise interface with a particular electronic device, the user must aim the handheld unit with sufficient accuracy to point it at the particular electronic device (or object associated with a desired electronic device). This aiming process is made more difficult by the fact that there is no interaction provided to the user in the way it would be had a user been reaching out to grab something in the real world. Specifically, when a user reaches out in the real world to, for example, flick a light switch, turn the knob on a radio, or press a button on a TV, the user gets an immediate and natural interaction in the form of tactile and/or force sensations (collectively referred to as tactile sensation). Upon sensing the real world tactile sensations, the user knows that his or her aim is correct and can complete the physical act of targeting and manipulating the object (i.e., flick the light switch, turn the knob, or press the button). Accordingly, it becomes difficult to accurately aim the handheld unit because there is no interaction provided to the user reassuring the user that the handheld device is, in fact, accurately aimed. Accordingly, it would be beneficial if a method and apparatus existed for naturally and rapidly informing a user, via an interaction, of his or her aim given to a handheld unit operateable within a ubiquitous computing environment. It would be even more beneficial if there existed a method and apparatus for naturally and rapidly informing the user of a multitude of events that transpire within a ubiquitous computing environment.

### SUMMARY

Several embodiments of the present invention advantageously address the needs above as well as other needs by providing a method and apparatus for point-and-send data transfer within a ubiquitous computing environment.

One embodiment of the present invention can be characterized as a computer implemented method of interfacing with electronic devices within a ubiquitous computing environment. Initially, a handheld unit is provided, wherein the handheld unit is adapted to be contacted and moved by a user within a ubiquitous computing environment. Next, sensor data is received from at least one sensor. In one embodiment, the sensor data includes information that indicates whether the handheld unit is substantially pointed at one of a plurality of electronic devices within the ubiquitous computing environment. In another embodiment, the sensor data includes information that indicates whether the handheld unit is within a predetermined proximity of one of the plurality of electronic devices within the ubiquitous computing environment. Based at least in part on the received sensor data, it is determined whether an electronic device within the ubiquitous computing environment has been selected by the user. In one embodiment, the user is provided with physical feedback through the handheld unit when it is determined that an electronic device within the ubiquitous computing environment has been selected. In another embodiment, data is transferred between the selected electronic device and the handheld unit over a pre-existing communication link.

In yet another embodiment, the sensor data includes information that indicates whether the handheld unit has been substantially pointed at electronic devices within the ubiquitous computing environment. Based at least in part on such sensor data, it is determined whether first and second electronic devices within the ubiquitous computing environment have been successively selected by the user. Data is subsequently transferred between the selected first and second electronic devices over a pre-existing network connection.

Another embodiment of the invention can be characterized as a system for interfacing with electronic devices within a ubiquitous computing environment. The system includes a handheld unit adapted to be contacted and moved by a user within a ubiquitous computing environment and at least one actuator within the handheld unit. The at least one actuator is adapted to generate forces when energized, wherein the generated forces are transmitted to the user as a tactile sensation. The system further includes at least one sensor and at least one processor. The at least one sensor is adapted to determine whether the handheld unit is substantially pointed at one of a plurality of electronic devices within the ubiquitous computing environment and to generate corresponding sensor data. The at least one processor is adapted to determine whether an electronic device within the ubiquitous computing environment has been selected by the user based on the generated sensor data. In one embodiment, the at least one processor is also adapted to energize the at least one actuator when it is determined that an electronic device has been selected. In another embodiment, the at least one processor is also adapted to initiate the transfer of data between the handheld unit and the selected electronic device over a pre-existing communication link.

In yet another embodiment, the at least one sensor is adapted to determine whether the handheld unit has been substantially pointed at electronic devices within the ubiquitous computing environment and generate corresponding sensor data. Additionally, the at least one processor is adapted to determine whether first and second electronic devices within the ubiquitous computing environment have been selected by the user using the generated sensor data and to initiate the transfer of data between the selected first and second electronic devices over a pre-existing network connection.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates an exemplary handheld unit 12 adapted for use in conjunction with numerous embodiments of the present invention;

FIGS. 2A-2C illustrate exemplary actuators that may be incorporated within a handheld unit 12 to deliver electronically controlled tactile sensations in accordance with numerous embodiments of the present invention; and

FIG. 3 illustrates a block diagram of an exemplary system architecture for use with the handheld unit 12 in accordance with one embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Numerous embodiments of the present invention are directed to methods and apparatus for enabling natural and informative physical feedback to users selecting, gaining access to, controlling, or otherwise interfacing with electronic devices within a ubiquitous computing environment.

Other embodiments of the present invention are directed to the natural and informative physical feedback to users transferring data files: (a) from an electronic device comprised within a ubiquitous computing environment of the user (i.e., a source electronic device) to a handheld unit that is held or otherwise carried about by the user; (b) from the handheld unit to an electronic device comprised within the ubiquitous computing environment of the user (i.e., a target electronic device); or (c) from a source electronic device to a target electronic device. As used herein, the term “data file” refers to substantially any digital record such as a .doc, .txt, .pdf file, or the like, or combinations thereof or any media file (e.g., music, image, movie, or the like, or combinations thereof), or the like, or combinations thereof.

In one embodiment, a source or target electronic device can be selected from within the ubiquitous computing environment by pointing the handheld unit substantially in the direction of the source or target electronic device, respectively. In another embodiment, a source or target electronic device can be selected from within the ubiquitous computing environment by bringing the handheld unit within a predetermined proximity of the source or target electronic device, respectively. In yet another embodiment, a source or target electronic device can be selected from within the ubiquitous computing environment by bringing the handheld unit within a predetermined proximity of the source or target electronic device, respectively, and by pointing the handheld unit substantially in the direction of the source or target electronic device, respectively. In still another embodiment, a source or target electronic device can be selected from within the ubiquitous computing environment by pointing the handheld unit as described above and/or bringing the handheld unit within a predetermined proximity as described above and performing an additional manipulation of the handheld unit (e.g., pressing a button on an interface of the handheld unit, moving the handheld unit in a predetermined motion, etc.).

Once source and/or target electronic devices are selected from within the ubiquitous computing environment of the user, data files may be transferred: (a) from the source electronic device to the handheld unit; (b) from the handheld unit to a target electronic device; or (c) from the source electronic device to the target electronic device. In one embodiment, data files may be transferred (in whole or in part) over a wireless communication link (e.g., a Bluetooth communication link). In another embodiment, the handheld unit and the source and/or target electronic device may be present upon a shared wireless communication network (e.g., a personal area network or piconet, as it is sometimes called).

In one embodiment, once the source and/or target electronic devices are selected from within the ubiquitous computing environment of the user data may be transferred as described above only after a user manipulates a user interface of the handheld unit (e.g., after a user presses a button on the handheld unit).

In one embodiment, the handheld unit may provide the user with physical feedback once a source or target electronic device is selected. In another embodiment, the handheld unit may provide the user with physical feedback once the handheld unit is successfully pointed to a source or target electronic device. In another embodiment, the handheld unit may provide the user with physical feedback once the handheld unit is successfully brought within a predetermined proximity to a source or target electronic device.

In one embodiment, the handheld unit may provide the user with physical feedback corresponding to predetermined events related to the transfer of data as described above. In another embodiment, the handheld unit may provide the user with physical feedback when data has begun being transferred as described above (e.g., when data has begun being received by the handheld unit from the source electronic device, when data has begun being received by the target electronic device from the handheld unit, or when data has begun being received by the target electronic device from the source electronic device). In another embodiment, the handheld unit may provide the user with physical feedback while data is being transferred as described above. In another embodiment, the handheld unit may provide the user with physical feedback when data has finished being transferred as described above (e.g., when data is completely received by the handheld unit from the source electronic device, when data is completely received by the target electronic device from the handheld unit, or when data is completely received by the target electronic device from the source electronic device).

In one embodiment, the handheld unit may provide the user with physical feedback corresponding to predetermined events related to authentication of the handheld unit for secure data transfer within the ubiquitous computing environment. In another embodiment, the handheld unit may provide the user with physical feedback when the handheld unit has been successfully authenticated for secure data transfer within the ubiquitous computing environment. In a further embodiment, the handheld unit may provide the user with physical feedback when the handheld unit has been unsuccessfully authenticated for secure data transfer within the ubiquitous computing environment.

In one embodiment, the handheld unit may be used to control or otherwise gain access to one or more electronic devices selected from within the ubiquitous computing environment (i.e., one or more selected target electronic devices). Accordingly, the handheld unit may provide the user with physical feedback corresponding to predetermined events related to commands transmitted from the handheld unit to a selected target electronic device. In one embodiment, the handheld unit may provide the user with physical feedback when a selected target electronic device has started a function in response to the command transmitted from handheld unit. In another embodiment, the handheld unit may provide the user with physical feedback when a selected target electronic device has completed a function in response to the command transmitted from handheld unit.

The physical feedback described above may be delivered to the user as an electronically controlled tactile sensation imparted by one or more actuators incorporated within the handheld unit. The tactile sensation can be felt by the user of the handheld device when the one or more actuators are energized. Depending upon how each actuator is energized, as described in greater detail below, a variety of distinct and identifiable tactile sensations can be produced by the one or more actuators under the control of electronics incorporated within the handheld unit. In one embodiment, the tactile sensations described in each of the embodiments above may be the same. In another embodiment, the tactile sensations described in at least two of the embodiments above may be different. Accordingly, different tactile sensations may be generated by electronically controlling the one ore more actuators differently.

For example, tactile sensations associated with any or all of the selection of a source and/or target electronic device, the transfer of data, the authentication of the handheld unit for use within the ubiquitous computing environment, and/or the events related to commands transmitted by the handheld unit may be different. In another example, tactile sensations associated with successfully pointing the handheld unit to a source and/or target electronic device and successfully bringing the handheld unit within a predetermined proximity of a source and/or target electronic device may be different. In another example, tactile sensations associated with initiating the transfer of data, continually transferring the data, completing the transfer of data may be different. In another example, tactile sensations associated with successful and unsuccessful authentication of the handheld unit for secure data transfer within the ubiquitous computing environment may be different. In another example, tactile sensations associated with initiation and completion of functions response to commands transmitted by the handheld unit may be different.

In accordance with general embodiments of the present invention, the tactile sensations are designed to be intuitive (i.e., such that the tactile sensations have physical meaning to the user). For example, a tactile sensation such as a jolt can be presented to the user when the user points successfully at a particular electronic device, the jolt feeling to the user as if he or she remotely felt the pointing alignment between the handheld unit and the electronic device. A long duration, low magnitude, high frequency vibration can be presented to the user as data is being transferred between the handheld unit and a selected electronic device, wherein the vibration providing an abstract feeling to the user as if he or she is actually feeling the data “flow” out of, or into, the handheld unit. A tactile jolt can be presented to the user when the data transfer is completed, the jolt indicating to the user that the data file has just finished flowing into or out of the handheld unit. These and other types of tactile sensations can be generated by an actuator and delivered to a user by controlling the profile of electricity flowing to the actuator in unique ways. For example, tactile sensations can be produced as a periodically varying force that has a selectable magnitude and frequency and duration as well an envelope that can be applied to the periodic signal, allowing for variation in magnitude over time. The resulting force signal can be “impulse wave shaped” as described in U.S. Pat. No. 5,959,613 which was invented by a same inventor as the present invention and is hereby incorporated by reference for all purposes as if fully set forth herein. Thus, numerous embodiments of the present invention provide a user with the sense of physically feeling the steps of selecting an electronic device, accessing the selected electronic device, initiating a data transfer, sending a data file, and completing a data transfer, all while using a handheld unit.

The handheld unit may be provided as an electronic device adapted to be held in the hand of the user, worn by the user, or otherwise carried about by the user within the ubiquitous computing environment. For example, the handheld unit can be a device such as a PDA, a portable media player, a portable data storage device, or other similar device that is adapted to be held in the hand of the user. In another embodiment, the handheld unit can be a device adapted to be worn like a watch on the wrist of the user.

Having generally described the various embodiments and examples above, more specific examples are provided below for purposes of illustration only.

In one exemplary implementation of the method and apparatus described above, a particular target electronic device may, for example, include a light switch within a house. Upon selecting the light switch as described above (e.g., by pointing the handheld unit at the light switch), the user can use the handheld unit to control the light switch (e.g., to turn a light connected to the light switch on or off or to adjust the brightness of the light) by manipulating the user interface of the handheld unit. The user can receive physical feedback from the handheld unit in the form of a tactile sensation when the handheld unit is successfully pointed at the light switch and/or after the handheld unit has gained access to light switch to control the light switch. In the present example, the physical feedback enables the user to know when the light switch has been selected only after which the light switch can be controlled.

In another exemplary implementation of the method and apparatus described above, a particular target electronic device may, for example, include a personal computer. After selecting the personal computer as described above (e.g., by pointing the handheld unit at the personal computer), the user can manipulate the user interface of the handheld unit (e.g., by pressing a “send” button) to transfer a data file from the handheld unit to the personal computer. The user can receive physical feedback from the handheld unit in the form of a tactile sensation when the handheld unit is successfully pointed at the personal computer and/or upon transferring the data file from the handheld unit to the personal computer. In the present example, the physical feedback enables the user to know when the personal computer has been selected only after which the data file can be transferred from the handheld unit to the personal computer.

In another exemplary implementation of the method and apparatus described above, a particular target electronic device may, for example, include a media player. After selecting the media player as described above (e.g., by pointing the handheld unit at the media player), the user can transfer a data file from the handheld unit to the media player. The user can receive physical feedback from the handheld unit in the form of a tactile sensation when the handheld unit is successfully pointed at the media player and upon transferring the data file from the handheld unit to the media player. In the present example, distinct forms of physical feedback may be optionally presented to the user such that the user can distinguish the sensation as “the feel of successful pointing at an electronic device” from sensations as “the feel of the data file starting to flow to the target electronic device,” “the feel of the data file steadily flowing to the target electronic device,” and/or “the feel of the data file ceasing to flow to the target electronic device.” The distinct forms of physical feedback enable the user to know when the media player has been selected, only after which the data file can be transferred from the handheld unit to the media player, and the status of the data file transfer. In the present example, the physical feedback is an abstract representation of the feel of a data file flowing from the handheld unit to the selected target electronic device (i.e., the media player). For example, the sensation of “the feel of the data file starting to flow to the target electronic device” can be abstracted by a soft, low magnitude vibration imparted by one or more actuators within the handheld unit, the sensation of “the feel of the data file steadily flowing to the target electronic device” can be abstracted by a hard, medium magnitude vibration imparted by one or more actuators within the handheld unit, and the sensation of “the feel of the data file ceasing to flow to the target electronic device” can be abstracted by a hard, high magnitude vibration imparted by one or more actuators within the handheld unit.

In another exemplary implementation of the method and apparatus described above, a particular source electronic device may, for example, include a personal computer. After selecting the personal computer as described above (e.g., by pointing the handheld unit at the personal computer), the user can manipulate the user interface of the handheld unit (e.g., by pressing a “send” button) to transfer a data file from the personal computer to the handheld unit. The user can receive physical feedback from the handheld unit in the form of a tactile sensation when the handheld unit is successfully pointed at the personal computer and/or upon transferring the data file from the personal computer to the handheld unit. In the present example, the physical feedback enables the user to know when the personal computer has been selected only after which the data file can be transferred from the personal computer to the handheld unit. Similar to the example provided above, distinct forms of physical feedback may be optionally presented to the user such that the user can distinguish the sensation as “the feel of successful pointing at an electronic device” from sensations as “the feel of the data file starting to flow to the handheld unit,” “the feel of the data file steadily flowing to the handheld unit,” and/or “the feel of the data file ceasing to flow to the handheld unit.”

In another exemplary implementation of the method and apparatus described above, the handheld unit may be used to command a selected source electronic device (e.g., a personal computer) to transfer a data file to a selected target electronic device (e.g., a media player). Upon selecting the personal computer as described above (e.g., by pointing the handheld unit at the personal computer and, optionally, pressing a button within the user interface of the handheld unit), the user can use the handheld unit to control the personal computer (e.g., transfer a data file to the media player) by manipulating the user interface of the handheld unit and pointing the handheld unit at the media player. The user can receive physical feedback from the handheld unit in the form of a tactile sensation when the handheld unit is successfully pointed at the personal computer and/or after the handheld unit has gained access to the personal computer to control the personal computer to transfer. The user can also receive physical feedback from the handheld unit in the form of a tactile sensation when the handheld unit is successfully pointed at the media player and/or after the personal computer has responded to a command to transfer a data file to the media player. As similarly described above, distinct forms of physical feedback ma optionally be presented to the used such that the user can be informed as to the initiation and/or completion of the data transfer from the first electronic device (i.e., the personal computer) and the second electronic device (i.e., the media player).

In the example provided above, the user may manually engage the user interface of the handheld unit to identify one or more data files the first electronic device is to transfer to the second electronic device. For example, by pointing the handheld unit at a personal computer the user can interface with the personal computer and cause the personal computer to send a particular media file to a media player. Using the methods and apparatus disclosed herein, the user can receive physical feedback from the handheld unit in the form of an electronically controlled tactile sensation when the handheld unit is successfully pointed at the personal computer and/or interfaced with the personal computer. In this way, the user is informed through a natural physical sensation that the handheld unit is successfully pointed at the personal computer and can now be used to issue commands to the personal computer. The user then issues a command (e.g., by pressing a button on the handheld unit) instructing the personal computer to transfer a media file to a media player comprised within the ubiquitous computing environment. The user may then receive additional physical feedback from the handheld unit in a form of a same or different tactile sensation when the personal computer begins sending the data file to the media player. The feedback is optionally distinct in form such that the user can distinguish the sensation as “the feel of data beginning to flow to a target electronic device.” In this way, the user is informed through a natural physical sensation that the data transfer commanded by the user through the handheld unit has been initiated by the first and second electronic devices. In addition, the user can receive physical feedback from the handheld unit in a form of a same or different tactile sensation when the personal computer completes the sending of the data file to the media player. The feedback is optionally distinct in form such that the user can distinguish the sensation as “the feel of data ceasing to flow to a target electronic device.” In this way, the user is informed through a natural physical sensation that the file transfer operation commanded by the user through the handheld unit has been completed by the first and second electronic devices. Also, using the methods and apparatus disclosed herein the user may additionally receive physical feedback from the handheld unit in the form of a different or same tactile sensation while the data file is in the process of being sent to the media player from the personal computer, informing the user that the data transfer is in process. The feedback is optionally distinct in form such that the user can distinguish the sensation as “the feel of data flowing to the target electronic device.” For example, the sensation can be a soft, low magnitude vibration imparted by the actuator within the handheld unit 12, the vibration an abstract representation of the feel of data file flowing from the handheld unit 12 to the selected electronic device. In some embodiments, the frequency of the vibration can be selected and imparted as an abstract representation of the speed of the data transfer, a higher speed data transfer being presented by a higher frequency vibration and a lower speed data transfer being represented by a lower frequency vibration. In this way the user is given a tactile sensation that indicates the relative speed of a given data transfer that is in process.

In another exemplary implementation of the method and apparatus described above, the handheld unit may be authenticated with respect to one or more electronic devices comprised within the ubiquitous computing environment to ensure secure data transmission with electronic devices within the ubiquitous computing environment. In one embodiment, authentication may be accomplished through an exchange of identification data between the handheld unit and the electronic device and/or through the exchange of identification data with some other electronic device that is networked to the selected electronic device and operative to authenticate secure connections with the selected electronic device. Using the methods and apparatus disclosed herein, the user can receive physical feedback from the handheld unit in the form of a tactile sensation when the handheld unit is successfully pointed at the target electronic device and/or interfaced with the target electronic device such that authentication data can be exchanged between the handheld unit and the target electronic device (and/or the other electronic device that is networked to the target electronic device and operative to authenticate secure connections with the selected electronic device).

In addition, the user can receive physical feedback from the handheld unit in the form of a tactile sensation when the authentication process has been successfully completed, the feedback being optionally distinct in form such that the user can distinguish the sensation as “the feel of authentication”. In some embodiments, the user may receive physical feedback from the handheld unit in the form of a tactile sensation when the authentication process has not been successful, the feedback being optionally distinct in form such that the user can distinguish the sensation as “the feel of a failed authentication”. In this way, a user can quickly point his or her handheld unit at a number of different electronic devices within a ubiquitous computing environment and quickly feel the difference between those that he or she can link with and those that he or she can not link with (or not link with securely). Because such sensations can only be felt by the user holding (or otherwise engaging) the handheld unit, such feedback is private—only the user who is pointing at the various devices knows the status of the authentication process, the file transfers, and other interactions between the handheld unit and the other devices within the ubiquitous computing environment.

As mentioned above, the user may receive a tactile sensation if the authentication process is successful and a different tactile sensation if the authentication process fails. In this way the user is informed through a natural and private physical sensation if and when authentication has occurred. In this way, the user may also be informed through a natural and private physical sensation if and when a secure interface link has been established between the handheld unit and another electronic device. This is particularly useful for embodiments wherein the handheld unit includes and/or is a personal data storage device. In this way the user can interface his or her personal data storage device wirelessly with an electronic device by pointing the data storage device in the appropriate direction of that electronic device and/or by coming within a certain proximity of that electronic device. The user can receive physical feedback in the form of a tactile sensation produced by an actuator local to the data storage device when the data storage device has been successfully authenticated and/or when the data storage device has been securely interfaced with the electronic device. In this way, a user can, for example, point his data storage device at a personal computer, interface securely with the personal computer, and optionally exchange personal data with the personal computer, all while receiving natural and private physical feedback informing the user of the status of the interface and data exchange process.

As described above, a handheld unit can be used to select an electronic device within the ubiquitous computing environment by, for example, pointing a handheld unit substantially in the direction of the electronic device. In one embodiment, an emitter such as a laser pointer is used in conjunction with an appropriate detector to determine which one of the plurality of electronic devices is being pointed at by the handheld unit. In another embodiment, position and orientation sensors may be used to track the pointing direction of the handheld unit. The pointing direction may then be compared with stored spatial representation data for the plurality of other electronic devices to determine which of the plurality of electronic devices, if any, is then currently being pointed at by the handheld unit. Additionally, other position and orientation sensing methods involving the use of, for example, GPS sensors, tilt sensors, magnetometers, accelerometers, RF sensors, ultrasound sensors, magnetic positioning sensors, and other position and/or orientation sensors incorporated within the handheld unit may be used to determine which of the plurality of electronic devices is being pointed at by the handheld unit such that the user of the handheld unit can gain access to, control, or otherwise interface with a desired one of a plurality of electronic devices. Further, other position and orientation sensing methods involving the use RFID chips, infra-red emitters and detectors, and or other means of emission and detection incorporated within the handheld unit and/or the plurality of electronic devices may be used to determine which of a plurality of electronic devices is being pointed at by a handheld unit such that the user of the handheld unit can gain access to, control, or otherwise interface with a desired one of the plurality of electronic devices.

According to one embodiment of the present invention, a handheld unit capable of interfacing with one of a plurality of electronic devices through a wireless connection based upon the relative location and/or orientation of the handheld unit with respect to the one electronic device. The invention also includes a “point-and-send” methodology in which a data file, such as a music file, image file, or other media file, is sent from the handheld unit to the one electronic device once the one electronic device has been interfaced with. As described above, some embodiments of the current invention include a handheld unit that connects to, gains control of, and/or accesses one of a plurality of available electronic devices within a ubiquitous computing environment by pointing at that one electronic device. In other embodiments, of the current invention the pointing must necessarily be coordinated with a particular motion gesture imparted upon the handheld unit by the user to successfully cause the handheld unit to connect to, gain control of, and/or access the one electronic device. In such embodiments the handheld unit may further include sensors for detecting such a gesture such as accelerometer sensors, tilt sensors, magnetometer sensors, and/or GPS positioning sensors. In other embodiments of the current invention the pointing must necessarily be coordinated with a button press or other manual input imparted upon the handheld unit by the user to successfully cause the handheld unit to connect to, gain control of, and/or access the one electronic device. In such embodiments the handheld unit may further include buttons, sliders, levers, knobs, dials, touch screens, and/or other manipulatable interfaces for detecting such a manual input. In other embodiments of the current invention the pointing may necessarily be coordinated with the handheld unit being within a particular proximity of the one electronic device to successfully cause the handheld unit to connect to, gain control of, and/or access the one electronic device. In such embodiments the handheld unit may further include sensors such as ultrasonic sensors, RF transmitters and/or receivers, infra red sensors and/or receivers, GPS sensors, and/or other sensors for detecting and/or reacting to the absolute and/or relative distance between the handheld electronic device and the one electronic device.

Alternately, some embodiments of the current invention include a handheld unit that connects to, gains control of, and/or accesses one of a plurality of available electronic devices within a ubiquitous computing environment not by pointing but instead by coming within a certain proximity of that one electronic device and/or by coming within a closer proximity of the one electronic device as compared to other of the plurality of electronic devices. In such embodiments the handheld unit may further include sensors such as ultrasonic sensors, RF transmitters and/or receivers, infra red sensors and/or receivers, GPS sensors, and/or other sensors for detecting and/or reacting to the absolute and/or relative distance between the handheld unit and the other electronic devices. In other embodiments of the current invention the coming within a certain proximity of that one electronic device and/or coming within a closer proximity of the one electronic device as compared to other of the plurality of electronic devices, must necessarily be coordinated with a particular motion gesture imparted upon the handheld unit by the user to successfully cause the handheld unit to connect to, gain control of, and/or access the one electronic device. In such embodiments, the handheld unit may further include sensors for detecting such a gesture such as accelerometer sensors, tilt sensors, magnetometer sensors, and/or GPS positioning sensors. In other embodiments of the current invention the coming within a certain proximity of that one electronic device and/or coming within a closer proximity of the one electronic device as compared to other of the plurality of electronic devices, must necessarily be coordinated with a button press or other manual input imparted upon the handheld unit by the user to successfully cause the handheld unit to connect to, gain control of, and/or access the one electronic device. In such embodiments the handheld unit may further include buttons, sliders, levers, knobs, dials, touch screens, and/or other manipulatable interfaces for detecting such a manual input.

In some preferred embodiments, the control unit includes a radio frequency (RF) transceiver and various sensors. The outputs of the sensors are periodically packaged as messages and transmitted using the RF transceiver to a base station, which also has a RF transceiver to receive the messages transmitted by the handheld unit. The base station also sends messages to the handheld unit using the RF transceivers. It should be noted that other bi-directional communication links can be used other than or in addition to RF. In a preferred embodiment a Bluetooth communication link is used to allow bidirectional communication to and from the handheld unit using RF. There may optionally be one or more digital video cameras included in the system, located so as to capture images of the environment in which the handheld unit is operating. A computer, such as a PC, is connected to the base station. Position messages and/or orientation messages and/or other sensor messages received by the base station from the handheld unit are forwarded to the computer, as are images captured by any optional video cameras. The computer is employed to compute the absolute and/or relative position and/or orientation of the handheld unit with respect to one or more electronic devices using the messages received from the handheld unit and optionally captured images from the cameras. The orientation and/or location of the handheld unit is in turn used to determine if the handheld unit is pointing at an electronic device (or pointing at location associated with an electronic device) and/or if the handheld unit is within a certain proximity of an electronic device (or brought within a certain proximity of a location associated with an electronic device), the device being controllable by the computer via a network connection. If the pointing condition is satisfied and/or the proximity condition is satisfied, the device is selected and can be controlled by the user through the handheld unit.

The conditions that must be satisfied to select an electronic device depends upon the embodiment. In some embodiments successful pointing of the handheld unit at an electronic device (or a location associated with an electronic device) is sufficient to select a particular device and thus the computer is configured to select the device from the plurality of available devices based only upon the position and orientation of the handheld unit with respect to the particular device (or the location associated with the particular device). In other embodiments bringing the handheld unit within a certain proximity of an electronic device (or a location associated with an electronic device) is sufficient to select a particular device and thus the computer is configured to select the device from the plurality of available devices based only upon the proximity of the handheld unit with respect to the particular device (or the location associated with the particular device). In other embodiments both successful pointing of the handheld unit at an electronic device (or a location associated with an electronic device) and the bringing the handheld unit within a certain proximity of an electronic device (or a location associated with an electronic device) is required to select a particular device and thus the computer is configured to select the device from the plurality of available devices based both upon the position and orientation of the handheld unit with respect to the particular device (or the location associated with the particular device) and upon the proximity of the handheld unit with respect to the particular device (or the location associated with the particular device). In yet other embodiments other conditions may also need to be satisfied such as the pointing being coordinated with an appropriate button press, gesture, or other manipulation of the handheld unit by the user as detected by sensors upon the handheld unit and reported in messages to the base station. In yet other embodiments other conditions may also need to be satisfied such as the proximity of the handheld unit with respect to a particular electronic device being coordinated with an appropriate button press, gesture, or other manipulation of the handheld unit by the user as detected by sensors upon the handheld unit and reported in messages to the base station. In such coordinated embodiments, the computer is configured to select the device from the plurality of available devices based upon the position and orientation of the handheld unit with respect to the particular electronic device and/or upon the proximity of the handheld unit with respect to the particular electronic device and based upon whether or not the successful pointing and/or appropriate proximity is coordinated in time with appropriate button presses, manual gestures, or other manipulations of the handheld unit by the user as detected by sensors.

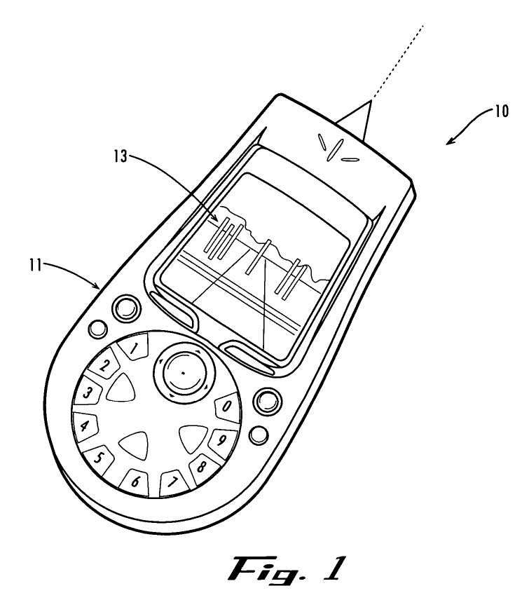

Also included within the handheld unit, is an actuator capable of generating a tactile sensation when appropriately energized under electronic control by electronics within the handheld unit. The actuator may include a rotary motor, linear motor, or other means of selectively generating physical forces under electronic control such that the forces that can be directed upon or otherwise imparted to a user who is holding the handheld unit such that the user feels the sensation while holding the handheld unit when the actuator is energized. In some embodiments the electronics within the handheld unit can energize the actuator with different control profiles thereby selectively creating a variety of different physical sensations that are individually distinguishable in feel by the user. An example of appropriate actuators and appropriate control electronics and appropriate control methods for delivering tactile sensations to a user is disclosed in issued U.S. Pat. No. 6,211,861, which was co-invented by Rosenberg (the same inventor as this current disclosure) and is hereby incorporated by reference. The actuators, such as those shown in FIG. 1 below, creates tactile sensations by moving an inertial mass under electronic control, the inertial mass being moved by the actuator to create rapidly changing forces that can be felt by the user as a distinct and informative tactile sensation.

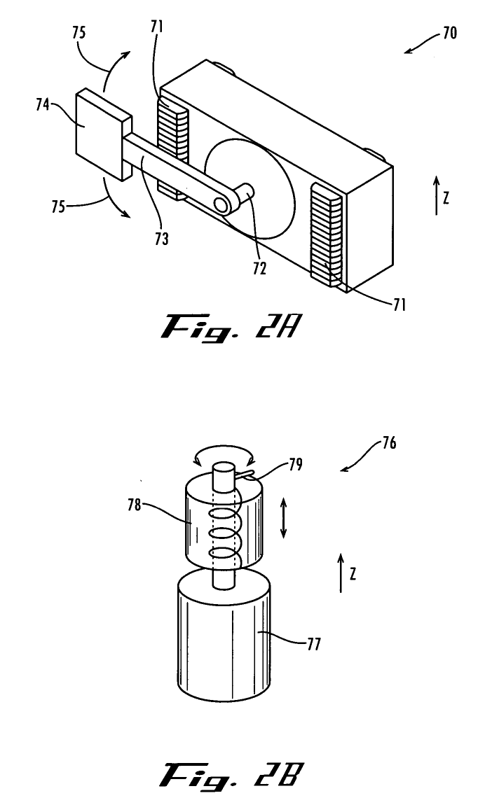

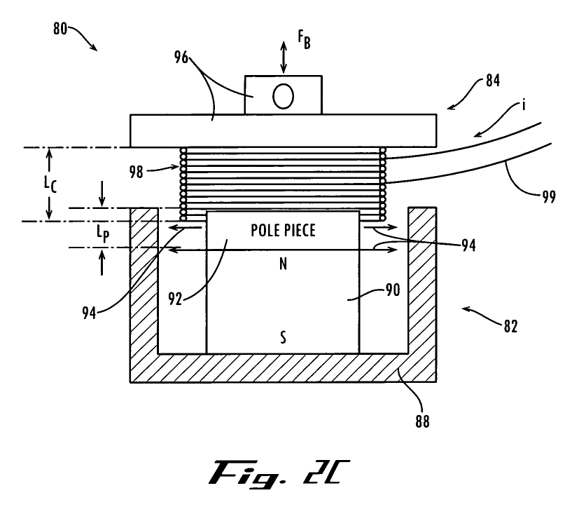

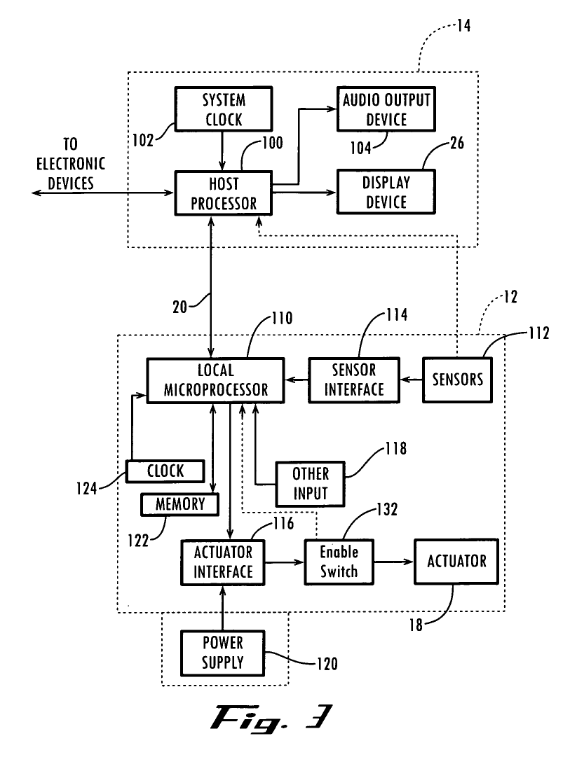

The handheld unit specifically includes a casing having a shape (in preferred embodiments) with a defined pointing end, a microcontroller, a wireless communication link such as the aforementioned RF transceiver, and position and orientation sensors which are connected to the microcontroller, and a power supply (e.g., batteries) for powering these electronic components. FIG. 2 shows an example system-architecture for the handheld unit and the computer system that the handheld unit communicates with through the wireless communication link. Also included is one or more actuators for generating and delivering tactile sensations. As described above, the actuator may be inertial actuators mounted to the casing of the handheld unit such that tactile sensations that are generated by the actuator are delivered to the user through the casing. In other embodiments, the actuators may be or may include piezoelectronic ceramics that vibrate when electronically energized and thereby stimulate the user. In other embodiments, the actuators may be or may include electro-active polymer actuators that deform when electronically energized. Regardless of what kind of actuator or actuators are used, the actuator or actuators are powered by the batteries through power electronics, the power electronics preferably including a power amplifier, the power electronics selectively controlled by the microcontroller such that the microcontroller can direct the power electronics to control the actuator or actuators to apply the tactile sensations to the user. Software running upon the microcontroller determines when to selectively apply the tactile sensations to the user based in whole or in part upon information received by the handheld unit over the communication link established by the RF transceiver. The tactile sensations may also be based in part upon sensor data processed by the microprocessor. The electronics may also include an enable switch with which a user can selectively enable or disable the haptic feedback capabilities of the device. For example, a user may wish to disable the feature if battery power is getting low and in danger of running out. Alternatively the microprocessor can automatically limit and/or disable the feature when battery power is getting low, the microprocessor monitoring battery level and then limiting and/or disabling the feature when the battery level falls below some threshold value.

In some embodiments, the handheld unit's microprocessor packages and transmits spatial location (position and/or orientation) messages at a prescribed rate. While the microcontroller could be programmed to accomplish this task by itself, a command-response protocol could also be employed such that the base station computer periodically instructs the handheld's microprocessor to package and transmit a spatial location message. This prescribed rate could for example be approximately 50 times per second. As indicated previously, the spatial location messages generated by the handheld unit include the outputs of the sensors (or are derived from outputs of the sensors). To this end, the handheld unit microcontroller periodically reads and stores the sensor values. This can include location sensors, orientation sensors, tilt sensors, acceleration sensors, GPS sensors, or whatever other sensors are used to determine the location, orientation, proximity, motion, or other spatial characteristic of the handheld unit with respect to the electronic devices within the environment. Whenever a request for a message is received (or it is time to generate such a message if the handheld unit is programmed to do so without a request), the microprocessor packages and sends the appropriate spatial location data to the base station computer.

The handheld unit may also include other electronic components such as a user activated switches or buttons or levers or knobs or touch screens or LCD displays or lights or graphical displays. These components, which are also connected to the microcontroller, are employed for the purpose providing information display to users and/or for allowing the user to provide manual input to the system. For example, buttons and/or switches and/or levers and/or graphically displayed and navigated menus, may be manipulated by the user for instructing an electronic device to implement a particular function. These input and output components are collectively referred to as the User Interface (UI) of the handheld unit. To this end, the state and/or status of the UI at the time a spatial location message is packaged, may be included in that message for transmission to the base station computer. In addition to sending messages to the base station computer as described above, the microcontroller receives messages from the base station computer. The messages received from the base station computer may include state and status information about one or more electronic devices that are networked to the base station computer. The messages received from the base station computer may, for example, include state and status information about the particular electronic device that is then currently being accessed, controlled, and/or interfaced with by the handheld unit (as determined by pointing and/or proximity). The message received from the base station computer may include information used by the microcontroller to determine if a tactile sensation should be delivered by the actuators to the user and/or to determine the type, magnitude, and/or duration of that tactile sensation. For example, if the home base computer determines that the handheld unit is successfully pointed at a particular electronic device, data representing that fact may be sent to the handheld unit. Upon receiving this data, the microcontroller within the handheld unit may determine that a tactile sensation should be delivered to the user to inform the user that the handheld unit is successfully pointing at the particular electronic device. The microcontroller may then select one of a plurality of tactile sensation routines stored in memory and cause the actuator to deliver the tactile sensation by sending an appropriate electronic signal to the actuator through the power electronics. When the user feels this tactile sensation and is thereby informed that the handheld unit is successfully pointing at the particular electronic device, the user may use the UI on the handheld unit to command the electronic device to perform some function. When the electronic device begins the function, the base station computer may send data to the microprocessor within the handheld unit informing the microprocessor that the electronic device has begun to perform the function. Upon receiving this data, the microprocessor within the handheld unit may determine that a tactile sensation should be delivered to the user to inform the user that the electronic device has begun performing the desired function. The micrprocessor may then select one of a plurality of tactile sensation routines from memory, the tactile sensation routines being optionally different from the previous sensation sent, and cause the actuator to deliver the selected tactile sensation by sending an appropriate electronic signal to the actuator through the power electronics. In this way the user feels a sensation informing him or her that the distant electronic device has begun performing a desired function. When the electronic device completes the function, the base station computer may send data to the microprocessor on board the handheld unit informing the micro that the device has completed the desired function. Upon receiving this data, the micro within the handheld unit may determine that a tactile sensation should be delivered to the user to inform the user that the electronic device has completed performing the desired function. The microprocessor may then select one of a plurality of tactile sensation routines from memory, the tactile sensation routines being optionally different from the two previous sensations sent, and cause the actuator to deliver the selected tactile sensation by sending an appropriate electronic signal to the actuator through the power electronics. In this way the user feels a sensation informing him or her that the distant electronic device has completed performing a desired function. In some simple embodiments there needs not be a plurality of tactile sensations to select from such that all three functions described above deliver the same tactile sensation to the user. In advanced embodiments a plurality of tactile sensations are used, the plurality of tactile sensations being distinguishable by feel by the user such that the user can come to learn what it feels like to be successfully pointing at an electronic device, what it feels like to have the electronic device begin a commanded function, and what it feels like to have the electronic device complete a commanded function, each of the types of feels being distinct. To achieve a plurality of tactile sensations that are distinguishable by feel by the user, the microprocessor on board the handheld unit can generate each of the plurality of tactile sensations by controlling the actuator with a different profile of energizing electricity. For example, one profile of energizing electricity might cause the actuator to impart a tactile sensation that feels to the user like a high frequency vibration that lasts for a short duration while another profile of energizing electricity might cause the actuator to impart a tactile sensation that feels to the user like a stronger vibration at a lower frequency that lasts for a longer duration. In this way the profile of energizing electricity, as controlled by the microprocessor on board the handheld unit, can vary the frequency, magnitude, and/or duration of the sensation felt by the user from sensation to sensation and/or during a single sensation.

It should also be noted that other actions central to the “point-and-send” file transfer methodology described herein can correspond with feel sensations beyond successful pointing, device beginning a function, and device ending a function. For example the handheld unit being brought within a particular proximity of an electronic device may be associated with a particular feel sensation. The feel sensation being, for example, a short duration, medium-magnitude, medium-frequency vibration. Also, for example, the handheld unit being authenticated for secure data transfer with an electronic device may be associated with a particular feel sensation. The feel sensation being, for example, a distinct sequence of three perceptible bursts of very short duration, medium-magnitude, high frequency vibrations. In this way the user can distinguish by feel both the events of coming within a particular proximity of an electronic device and of being authenticated for secure data transfer with the device.

With respect to ranges of values, the duration of a sensation can be very short, on the order of 20 to 30 milliseconds, which is the lower limit of what is perceptible by a human. The duration of sensations can also be long, on the order of seconds, which is on the upper limit of what begins to feel annoying and/or numbing to a user. With respect to the frequency of a vibratory sensation, the frequency value can be as high as a few hundred cycles per second, which is the upper limit of what is perceptible by a human. On the other end of the spectrum, the frequency of a vibratory sensation can be as low as a 1 cycle per second. With respect to the magnitude of a tactile sensation produced by the actuator under electronic control, it can vary from a small fraction of the maximum output of the actuator, such as 1%, to full output of the actuator (i.e., 100%). With these ranges in mind, the microprocessor on board the handheld unit can be configured in software to control the actuator (or actuators) within the handheld unit to produce a range of tactile sensations, the range of tactile sensations varying in magnitude, duration, and/or frequency, the magnitude being selectable within a range from a small percentage to a large percentage of the actuators output capability as driven by the control electronics, the frequency being selectable within a range from a low frequency such as 1 HZ to a high frequency such as 200 HZ, and the duration being selectable within a range such as from 20 milliseconds to 10000 milliseconds. Also, it should be noted that the microprocessor can vary the magnitude and/or frequency of the haptic output produced by the actuator (or actuators) across the duration of a single sensation. By varying the magnitude and/or frequency of the haptic output produced by the actuator (or actuators) during the duration of a sensation in a number of unique ways, a variety of distinct and user-differentiable tactile sensations can be commanded by the microprocessor.

The foregoing system is used to select a particular electronic device from among a plurality of electronic devices by having the user point at the particular electronic device with the handheld unit and/or come within a certain proximity of the particular electronic device. In some embodiments this entails the handheld unit as well as the plurality of other electronic devices being on a shared wireless network such as a Bluetooth network. In some embodiments this entails a base station computer that communicates with the handheld unit by wireless communication link and communicates with a plurality of electronic devices by wired and/or wireless communication links. In some embodiments the base station computer may be considered one of the plurality of electronic devices and may be accessed and/or controlled by the handheld unit when the handheld unit is pointed at the base station computer and/or comes within a certain proximity of the base station computer. In some embodiments the system functions by the base station computer receiving position and/or orientation messages transmitted by the handheld unit. Based upon the messages received, the computer determines if the handheld unit is pointing at and/or is within a certain proximity of a particular one of the plurality of the electronic devices. In addition, video output from video cameras may be used alone or in combination with other sensor data to ascertain the location of the handheld unit within the ubiquitous computing environment.

In one example embodiment, the base station computer derives the orientation of the handheld unit from the orientation sensor readings contained in the message received from the handheld unit as follows. First, the accelerometer and magnetometer output values contained in the message are normalized. Angles defining the pitch of the handheld unit about the x-axis and the roll of the handheld unit about the y-axis are computed from the normalized outputs of the accelerometer. The normalized magnetometer output values are then refined using these pitch and roll angles. Next, previously established correction factors for each axis of the magnetometer, which relate the magnetometer outputs to the predefined coordinate system of the environment, are applied to the associated refined and normalized outputs of the magnetometer. The yaw angle of the handheld unit about the z axis is computed using the refined magnetometer output values. The computed pitch, roll and yaw angles are then tentatively designated as defining the orientation of the handheld unit at the time the message was generated. It is next determined whether the handheld unit was in a right-side up or up-side down position at the time the message was generated. If the pointer was in the right-side up position, the previously computed pitch, roll and yaw angles are designated as the defining the finalized orientation of the handheld unit. However, if it is determined that the handheld unit was in the up-side down position at the time the orientation message was generated, the tentatively designated roll angle is corrected accordingly, and then the pitch, yaw and modified roll angle are designated as defining the finalized orientation of the handheld unit. In the foregoing description, it is assumed that the accelerometer and magnetometer of the handheld unit are oriented such that their respective first axis corresponds to the x-axis which is directed laterally to a pointing axis of the handheld unit and their respective second axis corresponds to the y-axis which is directed along the pointing axis of the handheld unit, and the third axis of the magnetometer correspond to the z-axis which is directed vertically upward when the handheld unit is positioned right-side up with the x and y axes lying in a horizontal plane.

For embodiments that use one or more video cameras to derive, alone or in part, the location and/or orientation of the handheld unit, an infrared (IR) LED can be included on the handheld unit that is connected to the microcontroller that is able to emit IR light outside the handheld unit's case when lit: The microcontroller causes the IR LEDs to flash. In some embodiments a pair of digital video cameras are used, each have an IR pass filter that results in the video image frames capturing only IR light emitted or reflected in the environment toward the camera. The cameras thereby capture the flashing from the handheld unit's IR LED which appears as a bright spot in the video image frames. The microcontroller causes the IR LED to flash at a prescribed rate that is approximately one-half the frame rate of the video cameras. This results in only one of each pair of image frames produced by a camera having the IR LED flashes depicted in it. This allows each pair of frames produced by a camera to be subtracted to produce a difference image, which depicts for the most part only the IR emissions and reflections directed toward the camera which appear in one or the other of the pair of frames but not both (such as the flash from the IR LED of the handheld unit device). In this way, the background IR in the environment is attenuated and the IR flash becomes the predominant feature in the difference image. The image coordinates of the pixel in the difference image that exhibits the highest intensity is then identified using a standard peak detection procedure. A conventional stereo image technique is then employed to compute the 3D coordinates of the flash for each set of approximately contemporaneous pairs of image frames generated by the pair of cameras using the image coordinates of the flash from the associated difference images and predetermined intrinsic and extrinsic camera parameters. These coordinates represent the location of the handheld unit (as represented by the location of the IR LED) at the time the video image frames used to compute them were generated by the cameras. In some embodiments a single camera can be used to determine the location of the handheld unit using techniques known to the art. For example, some embodiments can use a single camera as if it where a stereo pair of cameras by using split optics and segmenting the CCD array into a left and right image side. In some embodiments cameras are not used and are instead replaced by other sensor technologies for determining the location of the handheld unit within the ubiquitous computing environment. For example, in some embodiments GPS sensors are used upon the handheld unit.

The orientation and/or location of the handheld unit device is used to determine whether the handheld unit is pointing at an electronic device in the environment that is controllable by the computer and/or to determine whether the handheld unit is within certain proximity of an electronic device in the environment that is controllable by the computer. In order to do so using spatial sensors on board the handheld unit, the base station computer (and/or the handheld unit) must know what electronic devices are controllable and where they exist in the environment. In some embodiments this requires a model of the environment. There are a number of ways in which the base station computer (and/or the handheld unit) can store in memory a representation of the environment that includes the spatial location of a plurality of controllable electronic devices. For example, in one embodiment, the location of electronic devices within the environment that are controllable by the computer are modeled using 3D Gaussian blobs defined by a location of the mean of the blob in terms of its environmental coordinates and a covariance. In another embodiment, as disclosed in US Patent Application Publication No. 2003/0011467 entitled, System and method for accessing ubiquitous resources in an intelligent environment, which is hereby incorporated by reference, the locations of electronic devices are stored in a 2D mapping database. Whether the representation is 2D or 3D, modeling the spatial location of electronic devices and storing such models in memory is a valuable method for embodiments that use spatial sensors to determine the spatial relationship between the handheld unit and the plurality of electronic devices.

To create such a model, one embodiment requires the user to input information identifying the electronic devices that are to be included in the model, the information including the spatial location of the electronic device. In one preferred embodiment the user uses the handheld unit itself to aid in identifying the spatial location of the electronic device. For example, the user enters a configuration mode by activating a switch on the handheld unit device and traces the outline of a particular device about which information is being entered. Meanwhile, the base station computer is running a configuration routine that tracks the position and/or orientation of the handheld unit and uses such data to identify the spatial location of device being traced. When the user is done tracing the outline of the device being modeled, he or she deactivates the switch and the tracing procedure is deemed to be complete. In this way a user can use the spatial tracking capabilities of the handheld unit to indicate the spatial location of a plurality of different electronic devices within an environment.

In some embodiments alternate methods of modeling the location of electronic devices within an environment are used. For example, in one embodiment the method of modeling the location of electronic devices proceeds as follows: It begins by the user inputting information identifying an electronic device that is to be modeled. The user then repeatedly points the handheld unit at the device and momentarily activates a switch on the handheld unit, each time pointing the unit from a different location within the environment. Meanwhile, the base station computer is running a configuration procedure that causes requests for messages to be sent to the handheld unit at a prescribed request rate. Data received from the handheld unit is stored until the configuration process is complete. Based upon this data, a computed location for the electronic device is determined are stored.

Not all embodiments of the present invention require that a spatial model of the environment be stored. Also, it should be stated that not all embodiments of the present invention require that the handheld unit include a spatial location sensor and/or a spatial orientation sensor. For example, some embodiments of the present invention include emitter detector pairs (the emitter affixed to one of the handheld unit or the electronic device and the detector affixed to the other of the handheld unit or the electronic device) such that the system can simply detect if the handheld unit is pointed at a particular electronic device and/or if the handheld unit is within a certain proximity of a particular electronic device based upon the readings from the emitter detector pairs. Embodiments that use emitter detector pairs can therefore often be substantially simpler in configuration than those that use spatial position and/or spatial orientation sensors. As mentioned previously, an example of an embodiment that uses a laser-pointer based emission and detection techniques rather than spatial location techniques is disclosed in “Designing a universal remote control for the ubiquitous computing environment” which was published in EE Times on Jun. 16, 2003 and is hereby incorporated by reference. Similarly US Patent Application Publication No. 2003/0107888, entitled Remote controlled lighting apparatus and method, which is hereby incorporated by reference, discloses a handheld unit for selecting and controlling a particular light fixture from a plurality of available light fixtures by aiming a laser-pointer aboard the handheld unit to the desired light fixture as the means of selecting among the plurality. Such handheld embodiments can use both directional and omni-directional components to select and communicate with electronic devices.

In one embodiment consistent with the present invention, the user uses a built-in visible laser pointer in the handheld unit to select the device to be adjusted. In other embodiments other directional emissions, including non-visible emissions, are used for the selection process. Once pointing is achieved (as detected by an emission detector on board the electronic device) the electronic device being pointed at then transmits its unique address (via infrared or RF) to the handheld unit. This completes the selection process, the microprocessor on board the handheld unit running software consistent with the inventive methods and apparatus disclosed herein then commands the actuator to output a tactile sensation that informs the user by physical feel that successful pointing has been achieved. Now that the device has been selected, subsequent commands may be transmitted (preferably via RF) to the device without continued pointing at the device. Thus once an electronic device has been selected, the operator's attention may be directed elsewhere, such as towards the user interface on the handheld unit, and not remain focused on maintaining the pointing of the handheld unit at the electronic device.

FIG. 1 illustrates an exemplary handheld unit adapted for use in conjunction with numerous embodiments of the present invention.

Referring to FIG. 1, a handheld unit 12 may be configured with appropriate hardware and software to support numerous embodiments of the “point-and-send” file transfer method and system disclosed herein. In one embodiment, the handheld unit 12 is adapted to be held by a user and pointed at particular electronic devices. Pointing at particular electronic devices enables a user to interface with and transfer files while providing tactile sensations to the user. Generally, the tactile sensations inform the user of various events (e.g., successful pointing of the handheld electronic device toward an electronic device, successful completion of various stages of a point-and-send file transfer, etc.).

In general, the handheld unit 12 is constructed with a case 11 having a desired shape and which houses a number of off-the-shelf electronic components. For example, the handheld unit 12 may include a microprocessor which is connected to components such as an accelerometer that produces x-axis and y-axis signals (e.g., a 2-axis accelerometer model number ADXL202 manufactured by Analog Devices, Inc. of Norwood Mass.), a magnetometer (e.g., a 3-axis magnetometer model number HMC1023 manufactured by Honeywell SSEC of Plymouth, Minn.) that produces x, y and z axis signals, and a gyroscope (e.g., a 1-axis piezoelectric gyroscope model number ENC-03 manufactured by Murata Manufacturing Co., Ltd. of Kyoto, Japan).

In one embodiment, at least one manually-operatable switch may be connected to the microprocessor and disposed within the case 11. The switch could be a push-button switch (herein referred to as a button), however any type of switch may be employed. The button is used to support the “point-and-send” file transfer methodology in many embodiments as follows. Once the handheld unit 12 is successfully pointed at a desired electronic device, the user presses the button to indicate that a file should be transferred to that electronic device. In addition, the button may be used by the user to tell a base station host computer to implement some function. For example, the user might depress the button to signal to the base station host computer that the user is pointing at an electronic device he or she wishes to affect (e.g., by turning the electronic device on or off).

In one embodiment, the handheld unit 12 further includes transceiver with a small antenna and is controlled by the microprocessor. The transceiver may, for example, be provided as a 2.45 GHZ bidirectional radio frequency transceiver. In many embodiments, radio communication to and from the handheld electronic device is accomplished using a Bluetooth communication protocol. Accordingly, the handheld electronic device can join a Bluetooth personal area network.

In one embodiment, the handheld electronic device may further include one or more haptic actuators (not shown) disposed within the case 11 and controlled in response to signals output from the microprocessor.

In one embodiment, the handheld unit 12 may further be provided with a text and/or graphical display 13 disposed within the case 11 and controlled by the microprocessor to present a user interface (e.g., including menus) to the user. The display may be used to inform the user what files are currently stored within the memory on board the handheld unit 12. The user interface displayed upon the display enables the user to select a file from a plurality of files stored within the memory of the handheld unit 12. Once a file has been selected via the user interface, the user can then point the handheld unit 12 at a desired electronic device and depress the appropriate “send” button, thereby causing the selected file to be sent to the desired electronic device. In one embodiment, haptic feedback may be provided to the user through the one or more actuators included disposed within the case 11 in accordance with the successful completion of one or more events in the “point-and-send” procedure.

In one embodiment, the shape of the handheld unit 12 described above with respect to FIG. 1 is chosen such that it has an intuitively discernable front end (i.e., a pointing end) that is to be pointed towards an electronic device. It will be appreciated, however, that the handheld unit 12 can be substantially any shape that is capable of accommodating the aforementioned internal electronic components and actuators associated with the device. For example, the shape of the handheld unit 12 may resemble a portable radio or television or media player, an automobile key remote, a pen, a key chain (or acting as a key chain), an attachment for a key chain, a credit card, a wrist watch, a necklace, etc.

In another embodiment, the handheld unit 12 can be embedded within a consumer electronic device such as a PDA, a cell phone, a portable media player, etc. In this way, a user can keep a single device on their person, such as a portable media player, and use the media player to perform the various functions and features disclosed herein. Also, the handheld unit 12 can resemble or act as a portable memory storage device such as a flash memory keychain.

In one embodiment, the handheld unit 12 includes transparent portion that can be looked through by a user to aid in pointing at particular locations in physical space. For example, the handheld unit 12 may include a transparent view finder lens having cross-hairs. Accordingly, when the user peers through the view finder, the crosshairs appear upon the physical space being pointed at by the handheld unit 12. In another embodiment, the handheld unit 12 includes a laser pointer beam or other projection means to aid in pointing at particular locations within the physical space.

In one embodiment, the handheld unit 12 includes a fingerprint scanning sensor on an outer surface of the case 11. Data collected by the fingerprint scanning sensor may be used (in whole or in part) to authenticate a particular user when that user interfaces with one or more electronic devices. Appropriate fingerprint scanning and authentication technologies include those from Digital Persona. In one embodiment, physical feedback may be used to provide subtle and private feedback to a user regarding successful authentication based upon the fingerprint scan data and/or other identification information stored within the handheld unit 12. In this way, a user can put his or her finger upon the fingerprint scanning sensor and, if successfully authenticated based (in whole or in part) upon data collected by the sensor, receive a particular tactile sensation from one or more actuators within the handheld unit 12 that privately informs the user that he or she was successfully authenticated. Conversely, a user can put his or her finger upon the fingerprint scanning sensor and, if not successfully authenticated based (in whole or in part) upon data collected by the sensor, receive a different tactile sensation from the actuator within the handheld unit 12 that privately informs the user that he or she was not successfully authenticated.

FIGS. 2A-2C illustrate exemplary actuators that may be incorporated within a handheld unit 12 to deliver electronically controlled tactile sensations in accordance with numerous embodiments of the present invention.

In one embodiment a rotary inertial actuator 70, such as that shown in FIG. 2A may be incorporated within the handheld unit 12 exemplarily described above. Once energized, the rotary inertial actuator 70 generates forces and imparts a tactile sensation to the user. The forces generated by actuator 70 are inertially induced vibrations that can be transmitted to the user through the case 102 of the handheld unit 12. Actuator 70 includes a spinning shaft 72 which can be rotated continuously in one direction or oscillated back and forth by a fraction of a single revolution. An arm 73 is coupled to the shaft 72 approximately perpendicularly to the axis of rotation of the shaft. An inertial mass 74 is coupled to the other end of the arm 73. When the shaft 72 is rotated continuously or oscillated forces are imparted to the case 102 of the handheld unit 120 from the inertia of the moving inertial mass 74. The user who is holding the case 11 of the handheld unit 120 feels the forces as tactile sensations.

In one embodiment a linear inertial actuator 76, such as that shown in FIG. 2B may be incorporated within the handheld unit 12 exemplarily described above. Once energized, the linear inertial actuator 76 generates forces and imparts a tactile sensation to the user. A motor 77 or other electronically controllable actuator having a rotating shaft is also shown. An actuator plug 78 has a high-pitch internal thread which mates with a pin 79 extending from the side of the rotating shaft of the motor, thus providing a low cost lead screw. When the shaft is rotating, the pin causes the plug 78 to move up or down (i.e., oscillate) along the axis. When the shaft oscillates, the plug 78 acts as an inertial mass (or can be coupled to an inertial mass such as inertial mass 74) and an appropriate tactile sensation is provided to the case 11 of the handheld unit 12.

It will be appreciated that other types of actuators may be used instead of, or in addition to the actuators described above. For example, a solenoid having a vertically-moving portion can be used for the linear actuator. A linear voice magnet, DC current controlled linear motor, a linear stepper motor controlled with pulse width modulation of an applied voltage, a pneumatic/hydraulic actuator, a torquer (motor with limited angular range), a piezo-electric actuator, etc., can be used. A rotary actuator can be used to output a torque in a rotary degree of freedom on a shaft, which is converted to linear force and motion through a transmission, as is well known to those skilled in the art.

In one embodiment a voice coil actuator 80, such as that shown in FIG. 2C may be incorporated within the handheld unit 12 exemplarily described above. Once energized, the linear inertial actuator 80 generates forces and imparts a tactile sensation to the user. Voice coil actuator 80 is a low cost, low power component and has a high bandwidth and a small range of motion and is thus well suited for use with embodiments of the present invention. Voice coil actuator 80 includes a magnet portion 82 (which is the stationary portion 66) and a bobbin 84 (which is the moving portion 67). The magnet portion 82 is grounded and the bobbin 84 is moved relative to the magnet portion. In other embodiments, the bobbin 84 can be grounded and the magnet portion 82 can be moved. Magnet portion 82 includes a housing 88 made of a metal such as steel. A magnet 90 is provided within the housing 88 and a pole piece 92 is positioned on magnet 90. Magnet 90 provides a magnetic field 94 that uses steel housing 88 as a flux return path. Pole piece 92 focuses the flux into the gap between pole piece 92 and housing 88. The length of the pole piece 92 is designated as L.sub.P as shown. The housing 88, magnet portion 82, and bobbin 84 are preferably cylindrically shaped, but can also be provided as other shapes in other embodiments.

Bobbin 84 is operative to move linearly with respect to magnet portion 88. Bobbin 84 includes a support member 96 and a coil 98 attached to the support member 96. The coil is preferably wound about the support member 96 in successive loops. The length of the coil is designated as L.sub.C in FIG. 2C. When the bobbin is moved, the coil 98 is moved through the magnetic field 94. An electric current i is flowed through the coil 98 via electrical connections 99. As is well known to those skilled in the art, the electric current in the coil generates a magnetic field. The magnetic field from the coil then interacts with the magnetic field 94 generated by magnet 90 to produce a force. The magnitude or strength of the force is dependent on the magnitude of the current that is applied to the coil and the strength of the magnetic field. Likewise, the direction of the force depends on the direction of the current in the coil. The inertial mass 64 is preferably coupled to the bobbin 84 and moves linearly with the bobbin. The operation and implementation of force using magnetic fields is well known to those skilled in the art.

FIG. 3 illustrates a block diagram of an exemplary system architecture for use with the handheld unit 12 in accordance with one embodiment of the present invention.

Referring to FIG. 3, a base station computer system 14 is connected to a handheld unit 12 via a bidirectional wireless communication link. Although not shown, it will be appreciated that a network connection exists between the base station computer system 14 and a plurality of electronic devices comprising the ubiquitous computing environment are connected to the base station computer system 14 via the network connection. In some embodiments, the handheld unit 12 and other devices communicate over a shared Bluetooth network. In such embodiments, the base station computer system 14 may not be necessary as each electronic device comprising the ubiquitous environment can communicate directly with the handheld unit 12 as if it were the base station computer system 14.

In the illustrated embodiment, the base station computer system 14 includes a host microprocessor 100, a clock 102, a display device 26, and an audio output device 104. The host microprocessor 100 also includes other components such as random access memory (RAM), read-only memory (ROM), and input/output (I/O) electronics (all not shown). Display device 26 can display images, operating system applications, simulations, etc. Audio output device 104 (e.g., one or more speakers) is preferably coupled to host microprocessor 100 via amplifiers, filters, and other circuitry well known to those skilled in the art. Other types of peripherals can also be coupled to host processor 100 such as storage devices (hard disk drive, CD ROM drive, floppy disk drive, etc.), printers, and other input and output devices.

Handheld unit 12 is coupled to the base station computer system 14 by a bidirectional wireless communication link 20. The bi-directional wireless communication link 20 transmits signals in either direction between the base station computer system 14 and the handheld unit 12. Link 20 can be a Bluetooth communication link, a wireless Universal Serial Bus (USB) communication link, or other wireless link well known to those skilled in the art.

In one embodiment, handheld unit 12 includes a local microprocessor 110, one or more sensors 112, a sensor interface 114, an actuator interface 116, other input devices 118, one or more actuators 18, local memory 122, local clock 124, a power supply 120, and an enable switch 132.

The local microprocessor is separate from any processors in the base station computer system 14 and can be provided with software instructions to wait for commands or requests from the base station computer system 14, decode the command or request, and handle/control input and output signals according to the command or request. In addition, local processor 110 can operate independently of the base station computer system 14 by reading sensor data, reporting data, and controlling the actuator (or actuators) to produce appropriate tactile sensations. Suitable microprocessors for use as the local microprocessor 110 include the MC68HC711E9 by Motorola, the PIC16C74 by Microchip, and the 82930AX by Intel Corp. Local microprocessor 110 can include one microprocessor chip, multiple processors and/or co-processor chips, and/or digital signal processor (DSP) capability.

Local microprocessor 110 can receive signals from one or more sensors 112 via the sensor interface 114 and provide signals to actuator 18 in accordance with instructions provided by the base station computer system 14 over link 20. For example, in a local control embodiment, the base station computer system 14 provides high level supervisory commands to local microprocessor 110 over link 20, and local microprocessor 110 decodes the commands and manages low level control routines to read sensors, report sensor values, and control actuators in accordance with the high level commands. This operation is described in greater detail in U.S. Pat. Nos. 5,739,811 and 5,734,373, both incorporated by reference herein. The local microprocessor 110 reports data to the host computer, such as locative data that describes the position and/or orientation of the handheld unit 12 within the ubiquitous computing environment, such as proximity information that describes the distance between the handheld unit 12 and one or more electronic devices, such as data that indicates if the handheld unit 12 is successfully pointing at an electronic device, and such data that indicates if the handheld unit 12 is within a certain proximity of one or more electronic devices. The data can also describe the states of one or more of the aforementioned buttons and an enable switch 132. The host processor 100 uses the data to update executed programs. In the local control loop, actuator signals are provided from the local microprocessor 110 to actuator 18 and sensor data are provided from the various sensors 112 that are included within the handheld unit 12 and other input devices 118 (e.g., the aforementioned buttons) to the local microprocessor 110.

As used herein, the term “tactile sensation” refers to either a single force or a sequence of forces output by the one or more actuators 18 which provide a tactile sensation to the user. For example, vibrations, a single jolt, or a texture sensation are all considered “tactile sensations”. The local microprocessor 110 can process inputted sensor data to determine appropriate output actuator signals by following stored instructions. The local microprocessor 110 may use sensor data in the local determination of forces to be output on the handheld unit, as well as reporting locative data derived from the sensor data to the base station computer system 14.

In further embodiments, other hardware can be provided locally to handheld unit 12 to provide functionality similar to local microprocessor 110. For example, a hardware state machine incorporating fixed logic can be used to provide signals to the actuator 18 and receive sensor data from sensors 112, and to output tactile signals according to a predefined sequence, algorithm, or process. Techniques for implementing logic with desired functions in hardware are well known to those skilled in the art.

In a different, host-controlled embodiment, base station computer system 14 can provide low-level motor control commands over communication link 20, which are directly transmitted to the actuator 18 via microprocessor 110 or other circuitry. Base station computer system 14 thus directly controls and processes all signals to and from the handheld unit 12 (e.g., the base station computer system 14 directly controls the forces output by actuator 18 and directly receives sensor data from sensor 112 and input devices 118).

In one embodiment, signals output from the base station computer system 14 to the handheld unit 12 can be a single bit that indicates whether to activate one or more actuators 18. In another embodiment, signals output from the base station computer system 14 can indicate the magnitude (i.e., the strength at which an actuator 18 is to be energized). In another embodiment, signals output from the base station computer system 14 can indicate a direction (i.e., both a magnitude and a sense for which an actuator 18 is to be energized). In still another embodiment, the local microprocessor 110 can be used to receive a command from the base station computer system 14 that indicates a desired force value to be applied over time. The local microprocessor 110 then outputs the force value for the specified time period based on the command, thereby reducing the communication load that must pass between base station computer system 14 and handheld unit 12. In yet another embodiment, a high-level command, including tactile sensation parameters, can be passed by wireless communication link 20 to the local microprocessor 110. The local microprocessor 110 then outputs the applies the all of the tactile sensations independent of base station computer system 14, thereby further reducing the communication load that must pass between the base station computer system 14 and handheld unit 12. It will be appreciated, however, that any of the aforementioned embodiments may be combined as desired based upon, for example, the processing power of the host processor 100, the processing power of the local microprocessor 110, and the bandwidth available over the link 20.

Local memory 122 (e.g., RAM and/or ROM) is coupled to microprocessor 110 and is adapted to store instructions for the local microprocessor 110 as well as temporary data and any other data. For example, the local memory 122 can store force profiles (e.g., a sequence of stored force values) that can be output by the local microprocessor 110 to one or more actuators 18 and/or a look-up table of force values to be output to one or more actuators 18 based on whether or not the handheld unit 12 is successfully pointing at and/or is successfully within a certain proximity of a particular electronic device. In addition, a local clock 124 can be coupled to the local microprocessor 110 to provide timing data, similar to system clock 18 of base station computer system 14. In one embodiment, timing data provided by the local clock 124 may be used by the local microprocessor 110 to, for example, to compute forces output by actuator 18. In embodiments where the link 20 comprises a wireless USB communication interface, timing data for microprocessor 110 can be alternatively retrieved from the wireless USB signal (or other wireless signal).

In one embodiment, the base station computer system 14 can send data describing the locations of some or all the electronic devices present within the ubiquitous computing environment of the user (i.e., “spatial representation data”) to the local microprocessor 110. The local microprocessor 110 can store the spatial representation data within local memory 122 and use the spatial representation data to determine if the handheld unit 12 is pointing at and/or is within a certain proximity of one or more electronic devices within the ubiquitous computing environment of the user.

In another embodiment, the local microprocessor 110 can be provided with the necessary instructions or data to check sensor readings and determine output forces independently of base station computer system 14. For example, based upon readings from an emitter/receiver pair, the local microprocessor 110 can determine, independent of the base station computer system 14, whether the handheld unit 12 is successfully pointing at and/or is within a particular proximity of a particular electronic device. Based upon the independent determination, the local 110 microprocessor can send a signal to one or more actuators 18 aboard the handheld unit 12. Upon receipt of the signal, the one or more actuators 18 produce an appropriate tactile sensation to be felt by the user, thereby informing the user of the successful pointing and/or close proximity.

In another embodiment, the local memory 122 can store a plurality of predetermined force sensations sent by the local 110 microprocessor to the one or more actuators 18 aboard the handheld unit 12, wherein each of the plurality of predetermined force sensations are associated with particular electronic devices comprising the ubiquitous computing environment, particular functions performed by the electronic devices, the completion of particular functions by an electronic device, the initiation of particular functions by an electronic device, the successful pointing of the handheld unit 12 at an electronic device, the determination that the handheld unit 12 is within a certain proximity of an electronic device, the successful accessing of an electronic device by the handheld unit 12, the successful authentication of the handheld unit 12 by an electronic device, the successful downloading of a data file from the handheld unit 12 to the electronic device, the successful receipt of a data file by the handheld unit 12 from an electronic device, the successful establishment of a secure link between the handheld unit 12 and an electronic device, the successful identification of the user as a result of a data exchange from handheld unit 14 and an electronic device, or the like, or combinations thereof. In another embodiment, the base station computer system 14 can send force feedback signals directly to the handheld unit 12 via the wireless link 20, wherein the signals may be used by the local microprocessor 110 to generate tactile sensations on the actuator.

The local memory 122 can store a plurality of data files such as music files, image files, movie files, text files, or the like, or combinations thereof.

In one embodiment, one or more of the plurality of data files stored within the local memory 122 can be selected by a user manipulating the user interface of the handheld unit 12. Where the base station computer system 14 is present within the system architecture, the one or more selected data files are retrieved from the local memory 112, transmitted to the base station computer system 14 over the wireless communication link 20, and routed to the target electronic device via the network connection. Where the base station computer system 14 is not present within the system architecture, the one or more selected data files are retrieved from the local memory 122 and transmitted directly to the target electronic device over the wireless communication link 20.

In another embodiment, one or more data files can be transmitted over the wireless communication link 20 and stored within the local memory 112. Where the base station computer system 14 is present within the system architecture, one or more data files can be routed from a source electronic device to the base station computer system 14 via the network connection and the one or more routed data files are then transmitted to the handheld unit 12 over the wireless communication link 20 where they are stored within the local memory 112. Where the base station computer system 14 is not present within the system architecture, the one or more data files can be transmitted from the source electronic device directly to the handheld unit 12 over the wireless communication link 20, where they are stored within the local memory 112.

The local memory 122 can store personal identification information associated with the user, wherein the personal identification information is used in the authentication processes disclosed herein. Further, the local memory 122 can store information about the functionality of one or more other electronic devices comprising the ubiquitous computing environment of the user and that are accessible by the handheld unit 12.

Sensors 112 can be adapted to sense the position, orientation, and/or motion of the handheld unit 12 within the ubiquitous computing environment of the user and provide corresponding sensor data to local microprocessor 110 via the sensor interface 114. In another embodiment, the sensors 112 may be adapted to detect the presence of and/or strength of a signal (e.g., an RF signal, an IR signal, a visible light signal, an ultrasonic signal, or the like, or combinations thereof) transmitted by one or more electronic devices within the ubiquitous computing environment of the user and provide corresponding sensor data to local microprocessor 110 via the sensor interface 114. As discussed above, the local microprocessor 110 may, in some embodiments, transmit the sensor data to the base station computer system 14. In one embodiment, the sensor data includes information representing the position, orientation, and/or motion of the handheld unit 12 within the ubiquitous computing environment.

One or more actuators 18 (such as those described above with respect to FIGS. 2A-2C) can be adapted to transmit forces to the housing of the handheld unit 12 in response to actuator signals received from microprocessor 110 and/or base station computer system 14. In some embodiments, one or more actuators 18 may be provided to generate inertial forces by moving an inertial mass. As described herein, the one or more actuators 18 apply short duration force sensations to the case 11 of the handheld unit 12. In one embodiment, the actuator signals output by the local microprocessor 110 can cause the one or more actuators 18 to generate a “periodic force sensation,” wherein the periodic force sensation is characterized by a magnitude and a frequency (e.g., a sine wave, a square wave, a saw-toothed-up wave, a saw-toothed-down, a triangle wave, or the like, or combinations thereof). In another embodiment, an envelope can be applied to the actuator signal allowing for time-based variations in magnitude and frequency, resulting in a periodic force sensation that can be characterized as “impulse wave shaped,” as described in U.S. Pat. No. 5,959,613, which is hereby incorporated by reference for all purposes as if fully set forth herein.

Actuator interface 116 can be optionally connected between actuator 18 and local microprocessor 110 to convert actuator signals from local microprocessor 110 into signals appropriate to drive the one or more actuators 18. In one embodiment, actuator interface 116 can include power amplifiers, switches, digital to analog controllers (DACs), analog to digital controllers (ADCs), and other components, as is well known to those skilled in the art.

Other input devices 118 (including, for example, the aforementioned button) may be included within handheld unit 12 and send input signals to local microprocessor 110 or to the base station computer system 14 when manipulated by the user. Such input devices include buttons, dials, switches, scroll wheels, or other controls or mechanisms.

Power supply 120 includes, for example, batteries and is coupled to actuator interface 116 and/or one or more actuators 18 to provide electrical power to the one or more actuators 18. Enable switch 132 can optionally be included to allow a user to deactivate one or more actuators 18 for power consumption reasons (e.g., if batteries are running low).

As mentioned previously a variety of different tactile sensations can be imparted upon the user by the actuator (or actuators) as controlled by the microprocessor on board the handheld unit 12. While a wide range of tactile sensations are possible, a small number of examples are provided herewith for illustrative purposes.

Pointing Sensation—Software running upon the local microprocessor 110 of the handheld unit 12 can be configured to control the one or more actuator 18 to impart a sensation upon the user when it is determined that the handheld unit 12 is successfully pointing in the direction of a target electronic device among a plurality of accessible electronic devices, the sensation being a short jolt of moderate magnitude that informs the user of the pointing alignment. Because the pointing alignment can be momentary, the pointing sensation may only be imparted if the pointing alignment occurs for more than some threshold amount of time, such as 1500 milliseconds. The pointing sensation itself may be constructed as a constant force applied for a short amount of time, such as 500 milliseconds. The pointing sensation alternately may be a periodic vibration of a high frequency such as 80 HZ and a short duration such as 400 milliseconds. The pointing sensation can also be impulse wave shaped such that an initial impulse accentuates the onset of the sensation for increased perceptual impact.

Proximity Sensation—Software running upon the microprocessor of the handheld unit 12 can be configured to control one or more actuators 18 to impart a proximity sensation upon the user when it is determined that the handheld unit 12 as moved by the user comes within a certain minimum distance of a target electronic device among a plurality of accessible electronic devices and thereby interfaces with that device, the proximity sensation being a short jolt of maximum magnitude that informs the user of the proximity based interfacing. The proximity sensation itself may be constructed as a constant force applied for a short amount of time, such as 800 milliseconds. The proximity sensation alternately may be a periodic vibration of a moderate frequency such as 35 HZ and a moderate duration such as 1500 milliseconds. The proximity sensation can also be impulse wave shaped such that an initial impulse accentuates the onset of the proximity sensation for increased perceptual impact and period of fade eases-off the sensation at the end.

Successful Authentication Sensation—Software running upon the microprocessor of the handheld unit 12 can be configured to control one or more actuators 18 to impart a successful authentication sensation upon the user when it is determined that the user has been successfully authenticated based upon personal identification data stored within the handheld unit 12, the successful authentication sensation being a sequence of three short jolts of moderate magnitude that informs the user of the successful authentication. The successful authentication sensation itself may be constructed as three quick jolts, each of duration 240 milliseconds and each separated by 200 milliseconds of actuator off time, each of the jolts being constructed as a sinusoidal vibration of 80 HZ.

Unsuccessful Authentication Sensation—The software running upon the microprocessor of the handheld unit 12 can also be configured to control one or more actuators 18 to impart an unsuccessful authentication sensation upon the user when it is determined that the user has not been authenticated based upon personal identification data stored within the handheld unit 12, the unsuccessful authentication sensation being a sequence of two quick jolts of higher magnitude and lower frequency. The unsuccessful authentication sensation itself may be constructed as two quick jolts, each of duration 300 milliseconds and separated by 300 milliseconds of actuator off time, each of the jolts being constructed as a sinusoidal vibration of 20 HZ.

File Transfer Begin Sensation—Software running upon the microprocessor of the handheld unit 12 can be configured to control one or more actuators 18 to impart a file transfer begin sensation upon the user when it is determined that a file has begun being transferred from the handheld unit 12 to a selected electronic device, the file transfer begin sensation being a being a sinusoidal vibration of 40 HZ that lasts for a duration of 1200 milliseconds and is wave-shaped such that it begins at 10% strength and gradually rises to 80% strength over the first 1000 milliseconds of the duration.

File Transfer Duration Sensation—Software running upon the microprocessor of the handheld unit 12 can also be configured to control the actuator (or actuators) to impart a file transfer duration sensation upon the user when it is determined that a file is in the process of being transferred from the handheld unit 12 to a selected electronic device, the file transfer duration sensation being a vibration that lasts the duration of the file transfer, the frequency of the vibration being dependent upon the file transfer speed over the wireless communication link. For example the vibration can vary from 10 HZ up to 120 HZ based upon file transfer speed (in megabits per second) scaled such that the likely range of transfer speeds is spread linearly across the range from 10 HZ to 120 HZ.

File Transfer Complete Sensation—Software running upon the microprocessor of the handheld unit 12 can also be configured to control the actuator (or actuators) to impart a file transfer complete sensation upon the user when it is determined that a file has finished being transferred from the handheld unit 12 to a selected electronic device, the file transfer complete sensation being a sinusoidal vibration of 40 HZ that lasts for a duration of 1500 milliseconds and is wave-shaped such that it begins at 80% strength and gradually fades out to 10% strength over the final 1250 milliseconds of the duration.

While the above file transfer begin, duration, and complete sensations are imparted upon a user when the handheld unit 12 sends a data file to an electronic device, it will be appreciated that similar file transfer sensations can be imparted upon the user when the handheld unit 12 receives a data file from an electronic device.

While the invention herein disclosed has been described by means of specific embodiments, examples and applications thereof, numerous modifications and variations could be made thereto by those skilled in the art without departing from the scope of the invention set forth in the claims.

What is claimed is:

1. A computer implemented method of interfacing with electronic devices within a ubiquitous computing environment, comprising:
providing a handheld unit adapted to be contacted and moved by a user within a ubiquitous computing environment;
receiving sensor data from at least one sensor, the sensor data including information indicating whether the handheld unit is substantially pointed at one of a plurality of electronic devices within the ubiquitous computing environment;
determining whether an electronic device within the ubiquitous computing environment has been selected by a user based at least in part on the received sensor data; and
providing the user with physical feedback through the handheld unit when it is determined that an electronic device within the ubiquitous computing environment has been selected.

2. The computer implemented method of claim 1, wherein determining includes processing the received sensor data to determine whether the handheld unit remains substantially pointed at one of the plurality of electronic devices for more than a threshold amount of time.

3. The computer implemented method of claim 1, further comprising receiving user interface data, the user interface data including information representing manual input by the user via a user interface of the handheld unit.

4. The computer implemented method of claim 3, wherein determining includes determining whether an electronic device has been selected using the received sensor data and the user interface data.

5. The computer implemented method of claim 1, wherein the sensor data further includes information indicating whether the handheld unit is within a predetermined proximity of the one of the plurality of electronic devices.

6. The computer implemented method of claim 1, wherein determining includes processing the sensor data to determine whether the handheld unit is pointed more in the direction of one of plurality of electronic devices than others of the plurality of electronic devices.

7. The computer implemented method of claim 1, wherein providing the user with physical feedback includes:
energizing at least one actuator within the handheld unit; and
transmitting forces generated by the at least one energized actuator to the user as a tactile sensation.

8. The computer implemented method of claim 1, further comprising providing physical feedback to the user as a tactile sensation corresponding to the sensor data used in determining whether an electronic device within the ubiquitous computing environment has been selected by the user.

9. The computer implemented method of claim 1, further comprising transferring data between the selected electronic device and the handheld unit over a pre-existing communication link.

10. The computer implemented method of claim 9, wherein the pre-existing communication link includes a wireless communication link.

11. The computer implemented method of claim 10, further comprising transferring data between the selected electronic device and the handheld unit over a pre-existing network connection.

12. The computer implemented method of claim 9, further comprising providing physical feedback to the user as a tactile sensation corresponding to the status of data transfer between the selected electronic device and the handheld unit.

13. The computer implemented method of claim 12, further comprising providing the user with physical feedback through the handheld unit when data is initially transferred between the selected electronic device and the handheld unit, thereby informing the user that the data transfer has begun.

14. The computer implemented method of claim 12, further comprising providing the user with physical feedback through the handheld unit as data is transferred between the selected electronic device and the handheld unit, thereby informing the user that the data transfer is in process.

15. The computer implemented method of claim 12, further comprising providing the user with physical feedback through the handheld unit when data transfer between the selected electronic device and the handheld unit is complete, thereby informing the user that the data transfer is complete.

16. The computer implemented method of claim 12, further comprising providing physical feedback to the user as a tactile sensation corresponding to the speed at which data is transferred between the selected electronic device and the handheld unit.

17. The computer implemented method of claim 12, further comprising transferring the data from the selected electronic device to the handheld unit.

18. The computer implemented method of claim 12, further comprising transferring the data from the handheld unit selected electronic device to the handheld unit.

19. The computer implemented method of claim 1, further comprising:
processing the received sensor data to determine whether the handheld unit has been successively pointed at first and second electronic devices within the ubiquitous computing environment; and
transferring data between the selected first and second electronic devices.

20. The computer implemented method of claim 19, further comprising transferring data between the selected first and second electronic devices over a pre-existing network connection.

21. The computer implemented method of claim 1, further comprising:
authenticating the handheld unit with respect to the selected electronic device; and
providing the user with physical feedback through the handheld unit, the physical feedback adapted to inform the user of the authentication status of the handheld unit with respect to the selected electronic device.

22. A computer implemented method of interfacing with electronic devices within a ubiquitous computing environment, comprising:
providing a handheld unit adapted to be contacted and moved by a user within a ubiquitous computing environment;
receiving sensor data from at least one sensor, the sensor data including information indicating whether the handheld unit is within a predetermined proximity of one of the plurality of electronic devices within the ubiquitous computing environment;
determining whether an electronic device within the ubiquitous computing environment has been selected by a user based at least in part on the received sensor data; and
providing the user with physical feedback through the handheld unit when it is determined that an electronic device within the ubiquitous computing environment has been selected.

23. The computer implemented method of claim 22, wherein determining includes processing the received sensor data to determine whether the handheld unit remains within the predetermined proximity of one of the plurality of electronic devices for more than a threshold amount of time.

24. The computer implemented method of claim 22, further comprising receiving user interface data, the user interface data including information representing manual input by the user via a user interface of the handheld unit.

25. The computer implemented method of claim 24, wherein determining includes determining whether an electronic device has been selected using the received sensor data and the user interface data.

26. The computer implemented method of claim 22, wherein the sensor data further includes information indicating whether the handheld unit is substantially pointed at the one of the plurality of electronic devices.

27. The computer implemented method of claim 22, wherein determining includes processing the sensor data to determine whether the handheld unit is closer in proximity to one of plurality of electronic devices than others of the plurality of electronic devices.

28. The computer implemented method of claim 22, wherein providing the user with physical feedback includes:
energizing at least one actuator within the handheld unit; and
transmitting forces generated by the at least one energized actuator to the user as a tactile sensation.

29. The computer implemented method of claim 22, further comprising providing physical feedback to the user as a tactile sensation corresponding to the sensor data used in determining whether an electronic device within the ubiquitous computing environment has been selected by the user.

30. The computer implemented method of claim 22, further comprising transferring data between the selected electronic device and the handheld unit over a pre-existing communication link.

31. The computer implemented method of claim 30, wherein the pre-existing communication link includes a wireless communication link.

32. The computer implemented method of claim 31, further comprising transferring data between the selected electronic device and the handheld unit over a pre-existing network connection.

33. The computer implemented method of claim 30, further comprising providing physical feedback to the user as a tactile sensation corresponding to the status of data transfer between the selected electronic device and the handheld unit.

34. The computer implemented method of claim 33, further comprising providing the user with physical feedback through the handheld unit when data is initially transferred between the selected electronic device and the handheld unit, thereby informing the user that the data transfer has begun.

35. The computer implemented method of claim 33, further comprising providing the user with physical feedback through the handheld unit as data is transferred between the selected electronic device and the handheld unit, thereby informing the user that the data transfer is in process.

36. The computer implemented method of claim 33, further comprising providing the user with physical feedback through the handheld unit when data transfer between the selected electronic device and the handheld unit is complete, thereby informing the user that the data transfer is complete.

37. The computer implemented method of claim 33, further comprising providing physical feedback to the user as a tactile sensation corresponding to the speed at which data is transferred between the selected electronic device and the handheld unit.

38. The computer implemented method of claim 33, further comprising transferring the data from the selected electronic device to the handheld unit.

39. The computer implemented method of claim 33, further comprising transferring the data from the handheld unit selected electronic device to the handheld unit.

40. The computer implemented method of claim 22, further comprising:
processing the received sensor data to determine whether the handheld unit has been successively pointed at first and second electronic devices within the ubiquitous computing environment; and
transferring data between the selected first and second electronic devices.

41. The computer implemented method of claim 40, further comprising transferring data between the selected first and second electronic devices over a pre-existing network connection.

42. The computer implemented method of claim 22, further comprising:
authenticating the handheld unit with respect to the selected electronic device; and
providing the user with physical feedback through the handheld unit, the physical feedback adapted to inform the user of the authentication status of the handheld unit with respect to the selected electronic device.

43. A computer implemented method of interfacing with electronic devices within a ubiquitous computing environment, comprising:
providing a handheld unit adapted to be contacted and moved by a user within a ubiquitous computing environment;
receiving sensor data from at least one sensor, the sensor data including information indicating whether the handheld unit is substantially pointed at one of a plurality of electronic devices within the ubiquitous computing environment;
determining whether an electronic device within the ubiquitous computing environment has been selected by the user based at least in part on the received sensor data; and
transferring data between the selected electronic device and the handheld unit over a pre-existing communication link.

44. The computer implemented method of claim 43, wherein the pre-existing communication link includes a wireless communication link.

45. The computer implemented method of claim 43, further comprising transferring data between the selected electronic device and the handheld unit over a pre-existing network connection.

46. The computer implemented method of claim 43, further comprising transferring the data from the selected electronic device to the handheld unit.

47. The computer implemented method of claim 43, further comprising transferring the data from the handheld unit selected electronic device to the handheld unit.

48. The computer implemented method of claim 43, further comprising providing a tactile sensation to the user via the handheld unit, the tactile sensation corresponding to the status of data transfer between the selected electronic device and the handheld unit.

49. A computer implemented method of interfacing with electronic devices within a ubiquitous computing environment, comprising:
providing a handheld unit adapted to be contacted and moved by a user within a ubiquitous computing environment;
receiving sensor data from at least one sensor, the sensor data including information indicating whether the handheld unit has been substantially pointed at electronic devices within the ubiquitous computing environment;
determining whether first and second electronic devices within the ubiquitous computing environment have been successively selected by the user based at least in part on the received sensor data; and
transferring data between the selected first and second electronic devices over a pre-existing network connection.

50. The computer implemented method of claim 49, further comprising providing a tactile sensation to the user via the handheld unit, the tactile sensation corresponding to the status of data transfer between the selected first and second electronic devices.

51. A system for interfacing with electronic devices within a ubiquitous computing environment, comprising:
a handheld unit adapted to be contacted and moved by a user within a ubiquitous computing environment;
at least one actuator within the handheld unit, wherein the at least one actuator is adapted to generate forces when energized, the generated forces transmitted to the user as a tactile sensation;
at least one sensor adapted to determine whether the handheld unit is substantially pointed at one of a plurality of electronic devices within the ubiquitous computing environment and generate corresponding sensor data; and
at least one processor adapted to determine whether an electronic device within the ubiquitous computing environment has been selected by the user based on the generated sensor data and to energize the at least one actuator when it is determined that an electronic device has been selected.

52. The system of claim 51, wherein the at least one processor is adapted to determine whether an electronic device within the ubiquitous computing environment is selected based in part upon whether the handheld device is within a sufficiently near proximity of the electronic device.

53. The system of claim 51, wherein:
the handheld unit includes a user interface adapted to transmit user interface data to the at least one processor, the user interface data including information representing a command manually input by the user; and
the at least one processor is further adapted to determine whether an electronic device within the ubiquitous computing environment has been selected by the user based at least in part upon both the generated sensor data and the user interface data.

54. The system of claim 51, wherein the at least one processor is adapted to energize at least one actuator to transmit a tactile sensation corresponding to the generated sensor data used by the at least one processor to determine whether an electronic device within the ubiquitous computing environment has been selected by the user.

55. The system of claim 51, wherein the handheld unit further includes:
a memory adapted to store data; and
a radio frequency transceiver adapted to facilitate transferal of data between the selected electronic device and the memory over a pre-existing communication link, wherein
the at least one processor is further adapted to initiate the transfer of data between the memory and the selected electronic device via the radio frequency transceiver.

56. The system of claim 55, wherein the pre-existing communication link includes a wireless communication link.

57. The system of claim 56, further comprising a base station computer system communicatively coupled between the plurality of electronic devices and the handheld device.

58. The system of claim 57, wherein the base station computer system is adapted to facilitate the transfer of data between the selected electronic device and the handheld unit over a pre-existing network connection.

59. The system of claim 55, wherein the at least one processor is further adapted to energize at least one actuator to transmit a tactile sensation corresponding to the status of data transfer between the selected electronic device and the handheld unit.

60. The system of claim 59, wherein the at least one processor is further adapted to energize at least one actuator to transmit a tactile sensation when data is initially transferred between the selected electronic device and the handheld unit, thereby informing the user that the data transfer has begun.

61. The system of claim 59, wherein the at least one processor is further adapted to energize at least one actuator to transmit a tactile sensation as data is transferred between the selected electronic device and the handheld unit, thereby informing the user that the data transfer is in process.

62. The system of claim 59, wherein the at least one processor is further adapted to energize at least one actuator to transmit a tactile sensation when data transfer between the selected electronic device and the handheld unit is complete, thereby informing the user that the data transfer is complete.

63. The system of claim 59, wherein the at least one processor is further adapted to energize at least one actuator to transmit a tactile sensation corresponding to the speed at which data is transferred between the selected electronic device and the handheld unit.

64. The system of claim 55, wherein the at least one processor is further adapted to initiate the transfer of data from the selected electronic device to the handheld unit.

65. The system of claim 55, wherein the at least one processor is further adapted to initiate the transfer of data from the handheld unit to the selected electronic device.

66. The system of claim 51, wherein the at least one processor is further adapted to:
process the sensor data to determine whether the handheld unit has been successively pointed at first and second electronic devices within the ubiquitous computing environment; and
transfer data between the selected first and second electronic devices.

67. The system of claim 51, wherein:
the handheld unit is further adapted to be authenticated with respect to the selected electronic device; and
the at least one processor is further adapted to energize at least one actuator to transmit a tactile sensation informing the user of the authentication status of the handheld unit with respect to the selected electronic device.
